(19) United States
(12) Patent Application Publication
(10) Pub. No.: US 2014/0166171 A1
(43) Pub. Date: Jun. 19, 2014

(54) ENHANCING TREAD WEAR SPEED AND TRACTION PERFORMANCE

(71) Applicant: BRIDGESTONE CORPORATION, Tokyo (JP)

(72) Inventor: Daisuke Tamura, Tokyo (JP)

(73) Assignee: BRIDGESTONE CORPORATION, Tokyo (JP)

(21) Appl. No.: 13/713,113

(22) Filed: Dec. 13, 2012

(51) Int. Cl. B60C 11/12

(52) U.S. Cl. CPC B60C 11/12
USPC 152/209.18; 264/340

(57) ABSTRACT

Provided is a tire tread for a tire comprising a plurality of ribs or blocks, a plurality of grooves defined by adjacent ribs or blocks, and a plurality of sipes formed in each of the ribs or blocks. Each of the ribs or blocks has a length extending in a circumferential direction, a width extending in an axial direction, and a depth extending in a radial direction. Each of the sipes extends at an angle to the radial direction either between 0 and 70 degrees, inclusive; or between −70 and 0 degrees, inclusive. Each sipe may have a thickness between nano thickness and 0.50 mm, inclusive. Each sipe may be spaced along the circumferential direction from an adjacent sipe by some interval having a length that does not exceed 20 mm. The ratio of the interval length to a standard contact patch length is less than 0.062.

### BACKGROUND

The present subject matter relates generally to a tire tread. More, specifically, the present subject matter relates to a tire or tire tread comprising a feature that may enhance tread wear speed or enhance traction performance.

Tires provide a wearable interface between a vehicle upon which they are installed and a roadway upon which the vehicle is operated. Tires provide an interface through which the vehicle may apply force to the roadway and vice versa.

Traction performance is of interest as the forces that the vehicle may apply to the roadway and vice versa are a function of traction. It remains desirable to develop a method or apparatus to modify traction performance.

Tread wear is of interest as the service life of a tire is a function of tire wear. It remains desirable to develop a method or apparatus to modify tread wear.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Provided is a tire tread for a tire comprising a plurality of ribs or blocks, a plurality of grooves defined by adjacent ribs or blocks, and a plurality of sipes formed in each of the ribs or blocks. Each of the ribs or blocks has a length extending in a circumferential direction, a width extending in an axial direction, and a depth extending in a radial direction. Each of the sipes extends at an angle to the radial direction either between 0 and 70 degrees, inclusive; or between −70 and 0 degrees, inclusive. Each sipe may have a thickness between nano thickness and 0.50 mm, inclusive. Each sipe may be spaced along the circumferential direction from an adjacent sipe by some interval having a length that does not exceed 20 mm. The ratio of the interval length to a standard contact patch length is less than 0.062.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a view of one embodiment of a tire tread.

FIG. 2 is a view of one embodiment of a tire tread comprising five ribs.

FIG. 3 is a view of another embodiment of a tire tread comprising five ribs.

FIG. 4 is a view of another embodiment of a tire tread comprising five ribs.

FIG. 5 is a graph depicting the mileage per millimeter of tread wear as a function of remaining tread depth for multiple tires of each of three different tread patterns.

FIG. 6 is a graph depicting testing mileage to which multiple tires of each of three different tread patterns were subjected.

FIG. 7 is view of a contact patch.

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced without these specific details.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

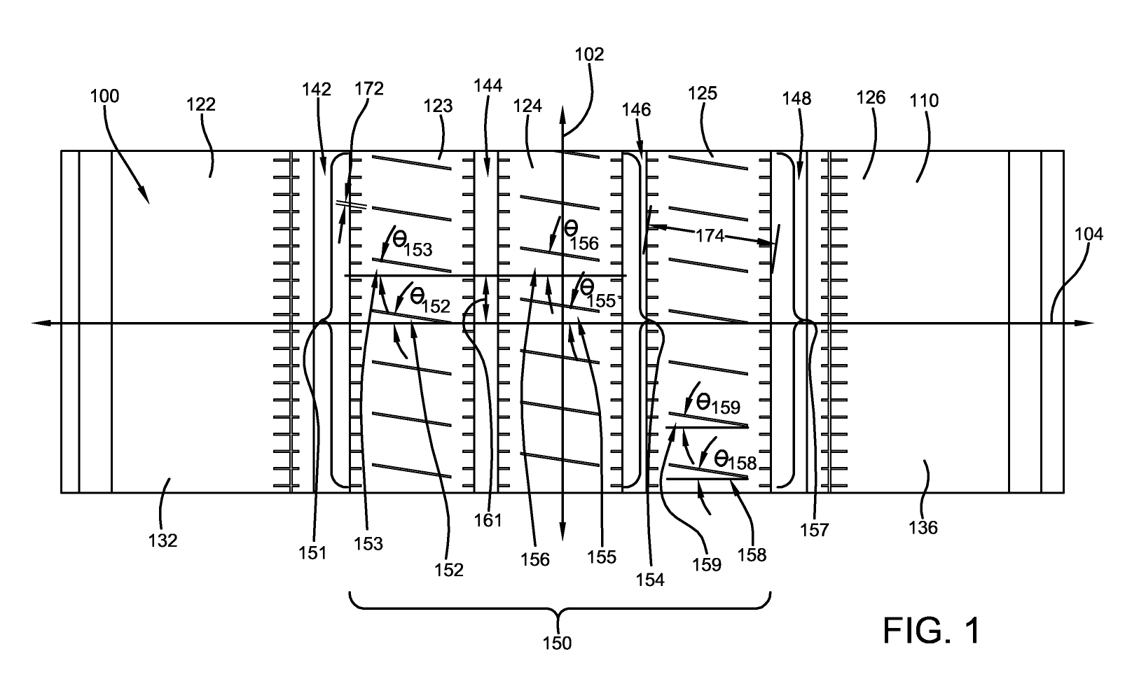

Referring now to FIG. 1, shown is a first, non-limiting embodiment of a tire 100. The tire 100 is shown with the circumferential direction 102 oriented vertically in FIG. 1, the axial direction 104 shown horizontally in FIG. 1, and the radial direction oriented normal to the view plane of FIG. 1. The tire 100 comprises a tire tread 110 comprising a first rib 122, a second rib 123, a third rib 124, a fourth rib 125, and a fifth rib 126. The first rib 122 and the fifth rib 126 are also components of the first shoulder 132 of the tire, and the second shoulder 136 of the tire, respectively. A first groove 142 is between and is defined by the first rib 122 and the second rib 123. A second groove 144 is between and is defined by the second rib 123 and the third rib 124. A third groove 146 is between and is defined by the third rib 124 and the fourth rib 125. A fourth groove 148 is between and is defined by the fourth rib 125 and the fifth rib 126.

The tire tread 110 comprises a plurality of sipes 150 formed in the ribs 123, 124, 125. Second rib 123 comprises a sipe set 151 comprising a sipe 152 and a sipe 153 adjacent to one another. Third rib 124 comprises a sipe set 154 comprising a sipe 155 and a sipe 156 adjacent to one another. Fourth rib 125 comprises a sipe set 157 comprising a sipe 158 and a sipe 159 adjacent to one another. A sipe 152, 153, 155, 156, 158, 159 is a thin, substantially elongated slot in a tire tread rib 122, 123, 124, 125, 126 or, in certain embodiments, a block. Any given sipe 152, 153, 155, 156, 158, 159 will have a length 174 and a thickness 172.

Each sipe 152, 153, 155, 156, 158, 159 is disposed at an angle θ₁₅₂, θ₁₅₃, θ₁₅₅, θ₁₅₆, θ₁₅₈, θ₁₅₉ to the radial direction 104. The angle θ₁₅₂, θ₁₅₃, θ₁₅₅, θ₁₅₆, θ₁₅₈, θ₁₅₉ with respect which any given sipe 152, 153, 155, 156, 158, 159 is disposed to the radial direction 104 may differ from the angle θ₁₅₂, θ₁₅₃, θ₁₅₅, θ₁₅₆, θ₁₅₈, θ₁₅₉ with respect to which any other sipe 152, 153, 155, 156, 158, 159 is disposed to the radial direction 104. In certain embodiments, all of the angles θ₁₅₂, θ₁₅₃, θ₁₅₅, θ₁₅₆, θ₁₅₈, θ₁₅₉ with respect which a given sipe 152, 153, 155, 156, 158, 159 is disposed to the radial direction 104 are either within a first range of angles, where all angles are equal to or greater than 0 degrees and equal to or less than 70 degrees, or are within a second range of angles, where all angles are equal to or greater than −70 degrees and equal to or less than 0 degrees, but do not comprise angles selected from both ranges of angles. That is, in certain embodiment, either the angles of the sipes will all be non-negative, or the angles of the sipes will all be non-positive. In some embodiments, the angle θ₁₅₂, θ₁₅₃, θ₁₅₅, θ₁₅₆, θ₁₅₈, θ₁₅₉ with respect which any given sipe 152, 153, 155, 156, 158, 159 is disposed to the radial direction 104 is within a first range of angles, where all the angles are between 0 degrees and 70 degrees, inclusive. In other embodiments, the angle θ₁₅₂, θ₁₅₃, θ₁₅₅, θ₁₅₆, θ₁₅₈, θ₁₅₉ with respect which any given sipe 152, 153, 155, 156, 158, 159 is disposed to the radial direction 104 is within a second range of angles, where all angles are between −70 degrees and 0 degrees, inclusive.

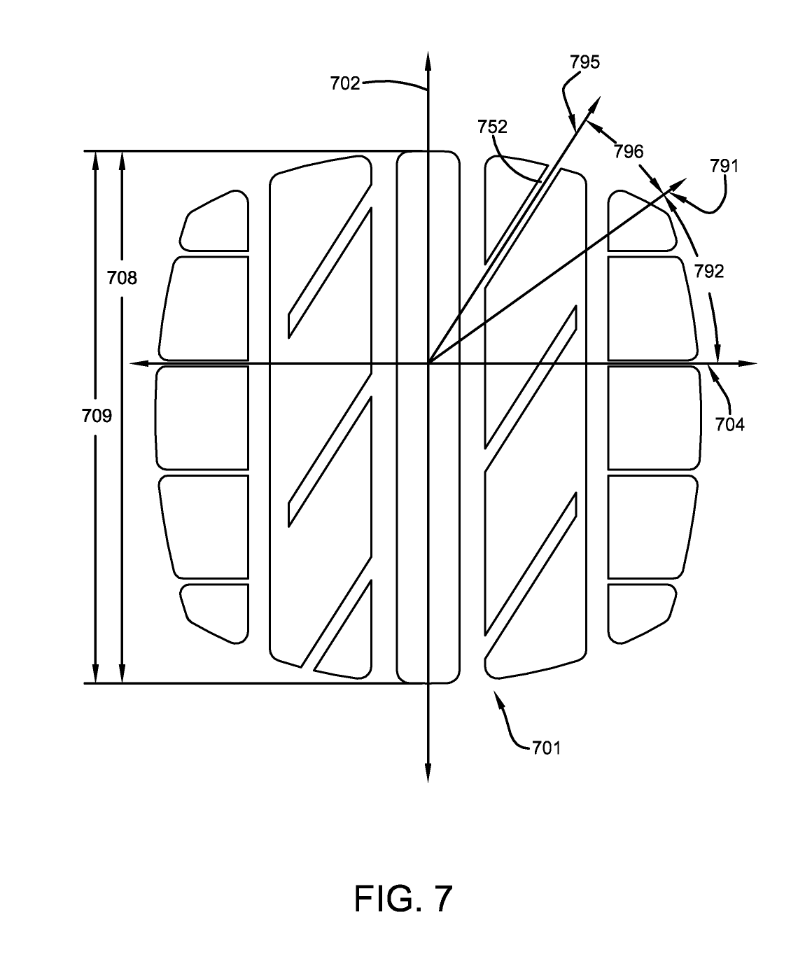

With reference now to FIG. 7, there are other equally acceptable ways of describing the angle with which a sipe 752 is disposed with respect to a known direction. With continued reference to the non-limiting embodiment shown in FIG. 7, one way of describing the direction of a sipe 752 is to describe it in terms of a reference direction 791 disposed at some reference angle 792 to a known direction, such as without limitation, axial direction 704, and, optionally, in terms of a deviation direction 795 disposed at some deviation angle 796 with respect to the reference direction 791. That is, a sipe 752 may extend in a deviation direction 795, where deviation direction 795 is disposed at a deviation angle 796 from reference direction 791, where reference direction 791 is disposed at a reference angle 792 from the axial direction 704. In certain embodiments, the deviation angle 796 may be defined to be within some range, such as, without limitation, between −35 and 35 degrees, inclusive. In certain embodiments, the reference angle 792 may be defined to be within some range, such as, without limitation, between −35 and 35 degrees, inclusive. In certain embodiments, the deviation angle 796 may be defined to be within some range, such as, without limitation, between −10 and 10 degrees, inclusive. In certain embodiments, the reference angle 792 may be defined to be within some range, such as, without limitation, between −60 and 60 degrees, inclusive.

The thickness 172 of a sipe 152, 153, 155, 156, 158, 159 may be as great as 2.00 mm or as slight as nano thickness. As the term is used herein, “nano thickness” refers to a thickness 172 marginally greater than the thickness 172 of those sipes formed by a razor, thin knife, laser, or a similarly thin cut made by other technology. That is, a nano thickness sipe is the thinnest sipe that is not as thin as would be a sipe formed by a razor, thin knife, laser, or a similarly thin cut made by other technology. In some embodiments, a sipe 152, 153, 155, 156, 158, 159 will have a thickness greater than nano thickness and less than or equal to 2.00 mm. In some embodiments a sipe 152, 153, 155, 156, 158, 159 will have a thickness greater than 0.10 mm and less than or equal to 0.45 mm. In some embodiments a sipe 152, 153, 155, 156, 158, 159 will have a thickness greater than 0.25 mm and less than or equal to 0.35 mm.

The length 174 of a sipe 152, 153, 155, 156, 158, 159 may extend across the rib 122, 123, 124, 125, 126 or, in other embodiments, the block, in which the sipe is formed. As noted above, in the non-limiting embodiment shown in FIG. 1, the sipes 152, 153, 155, 156, 158, 159 each extend at an angle θ₁₅₂, θ₁₅₃, θ₁₅₅, θ₁₅₆, θ₁₅₈, θ₁₅₉ with respect to the axial direction, each sipe in sipe set 151 extends between groove 142 and groove 144, each sipe in sipe set 154 extends between groove 144 and groove 146, and each sipe in sipe set 157 extends between groove 146 and groove 148. Accordingly, the length 174 of any given sipe 152, 153, 155, 156, 158, 159 in FIG. 1 is the width of the rib 123, 124, 125 in which the sipe is formed divided by the cosine of the angle θ₁₅₂, θ₁₅₃, θ₁₅₅, θ₁₅₆, θ₁₅₈, θ₁₅₉ at which the sipe 152, 153, 155, 156, 158, 159 extends with respect to the axial direction. For example, the length of sipe 152 is the width of rib 123 as measured in the axial direction 104 divided by the cosine of angle θ₁₅₂. As noted above, the angle θ₁₅₂, θ₁₅₃, θ₁₅₅, θ₁₅₆, θ₁₅₈, θ₁₅₉ at which a sipe 152, 153, 155, 156, 158, 159 extends with respect to the axial direction may deviate from 0 by as much as +/−70 degrees. For example, and without limitation, if a sipe 152 for which the angle θ₁₅₂, at which the sipe 152 extends with respect to the axial direction 104 is 70 degrees, then the length of the sipe 152 will be approximately 2.9 times the width of the rib 123, since 1/cos(70) is approximately 2.9.

A sipe 152 may be spaced along the circumferential direction 102 from an adjacent sipe 153 by some interval 161. The length of the interval 161 is measured in the circumferential direction 102. The length of the interval 161 may be constant with respect to axial position if the angles θ₁₅₂, θ₁₅₃ of the adjacent sipes 152, 153 are equal. The length of the interval 161 may be variable with respect to axial position if the angles θ₁₅₂, θ₁₅₃ of the adjacent sipes 152, 153 are not equal. In the non-limiting embodiment shown in FIG. 1, the angles θ₁₅₂, θ₁₅₃, θ₁₅₅, θ₁₅₆, θ₁₅₈, θ₁₅₉ of the sipes 152, 153, 155, 156, 158, 159 are all 5.5 degrees, so the length of each interval 161 is constant. In the embodiment shown in FIG. 1, the length of the interval 161 is approximately 12.7 mm. In certain embodiments, the length of the interval 161 may be between 0 mm and 20 mm.

Referring now to FIG. 7, a tire 100 placed in an operational orientation with respect to an operational surface and subjected to a load will have some contact patch 701 in contact with the operational surface. A contact patch 701 has a contact patch length 708 defined by the greatest dimension of the contact patch as measured in the longitudinal direction of the contact patch 702, which is parallel to the circumferential direction 102 of the tire 100 forming the contact patch 701. A tire 100 will have some standard load and some standard inflation pressure. When a tire 100 is inflated to its standard inflation pressure and subjected to the standard load on a substantially flat operational surface, the contact patch length 708 may be considered the standard contact patch length 709 for that tire 100. In the embodiment shown in FIG. 1, the standard contact patch length 709 for tire 100 is 225 mm.

The ratio of the length of an interval 161 to that of the standard contact patch length 709 for a tire 100 may be calculated and referred to as a “standard interval-contact patch ratio.” For a tire in which there are intervals 161 of differing lengths, there will also be more than one standard interval-contact patch ratio. In the embodiment shown in FIG. 1, the length of the interval 161 is approximately 12.7 mm, the length is the same for all of the intervals 161, and the standard contact patch length 709 for tire 100 is 225 mm, so the standard interval-contact patch ratio is calculated as 12.7/225=0.056. That is, in the embodiment shown in FIG. 1, the standard interval-contact patch ratio is 0.056. In certain embodiments, all of the standard interval-contact patch ratios for a tire will be less than 0.062.

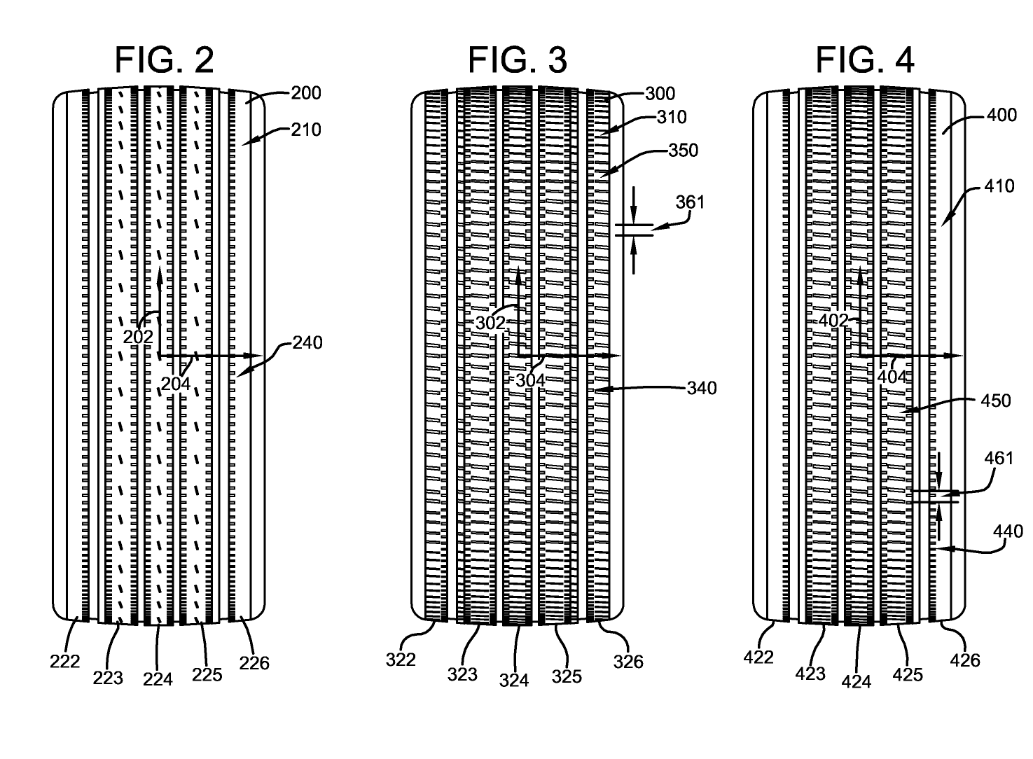

A first set of tests was performed on a plurality of tires of the embodiment shown in FIG. 2 wherein each tire 200 had a circumferential direction 202 defined by the circumference of the tire 200, an axial direction 204 parallel to the axis of operational rotation of the tire 200 and perpendicular to the circumferential direction 202, and a radial direction mutually perpendicular to both the circumferential direction 202 and to the axial direction 204. Each tire 200 comprised a tire tread 210 comprising five ribs 222, 223, 224, 225, 226. Ribs 222, 223, 224, 225, 226 each comprised a plurality cavities, referred to herein as rib edge cavities 240. A rib edge cavity 240, 340, 440 is a type of very short elongated narrow cavity. As used herein, a rib edge cavity 240, 340, 440 will be distinguished from a sipe 152, 153, 155, 156, 158, 159, 350, 450, 752 in that the length of a rib edge cavity is less than 10% of the width of the rib or block in which the rib edge cavity 240, 340, 440 is formed while a sipe 152, 153, 155, 156, 158, 159, 350, 450, 752 will have a length substantially greater than 10% of the width of the rib or block in which it is formed. The first set of tests comprised operations during which each tire 200 was driven over a roadway surface permitting data regarding mileage driven and tread wear to be recorded.

A second set of tests was performed on a plurality of tires of the embodiment shown in FIG. 3 wherein each tire 300 had a circumferential direction 302 defined by the circumference of the tire 300, an axial direction 304 parallel to the axis of operational rotation of the tire 300 and perpendicular to the circumferential direction 302, and a radial direction mutually perpendicular to both the circumferential direction 302 and to the axial direction 304. Each tire 300 comprised a tire tread 310 comprising five ribs 322, 323, 324, 325, 326. The ribs 322, 323, 324, 325, 326 comprised a plurality of sipes 350 in which each sipe 350 was oriented at an angle of 5.5 degrees with respect to the axial direction, and each sipe 350 was offset from neighboring sipes 350 by an interval 361 of 12.7 mm. The ribs 322, 323, 324, 325, 326 also comprised rib edge cavities 340. The second set of tests comprised operations during which each tire 300 was driven over a roadway surface permitting data regarding mileage driven and tread wear to be recorded.

A third set of tests was performed on a plurality of tires of the embodiment shown in FIG. 4 wherein each tire 400 had a circumferential direction 402 defined by the circumference of the tire 400, an axial direction 404 parallel to the axis of operational rotation of the tire 400 and perpendicular to the circumferential direction 402, and a radial direction mutually perpendicular to both the circumferential direction 402 and to the axial direction 404. Each tire 400 comprised a tire tread 410 comprising five ribs 422, 423, 424, 425, 426. The ribs 422, 426, comprised a plurality of rib edge cavities 440. The ribs 423, 424, 425, comprised a plurality of sipes 450 in which each sipe 450 was oriented at an angle of 5.5 degrees with respect to the axial direction, and each sipe 450 was offset from neighboring sipes 450 by an interval 461 of 12.7 mm. The ribs 423, 424, 425, also comprised rib edge cavities 440. The third set of tests comprised operations during which each tire 400 was driven over a roadway surface permitting data regarding mileage driven and tread wear to be recorded.

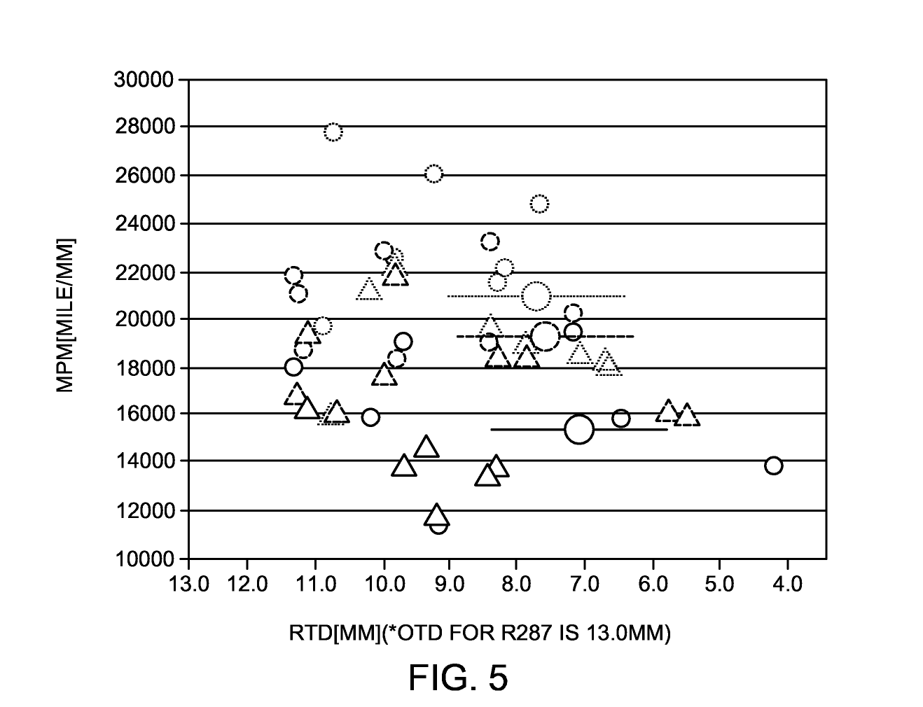

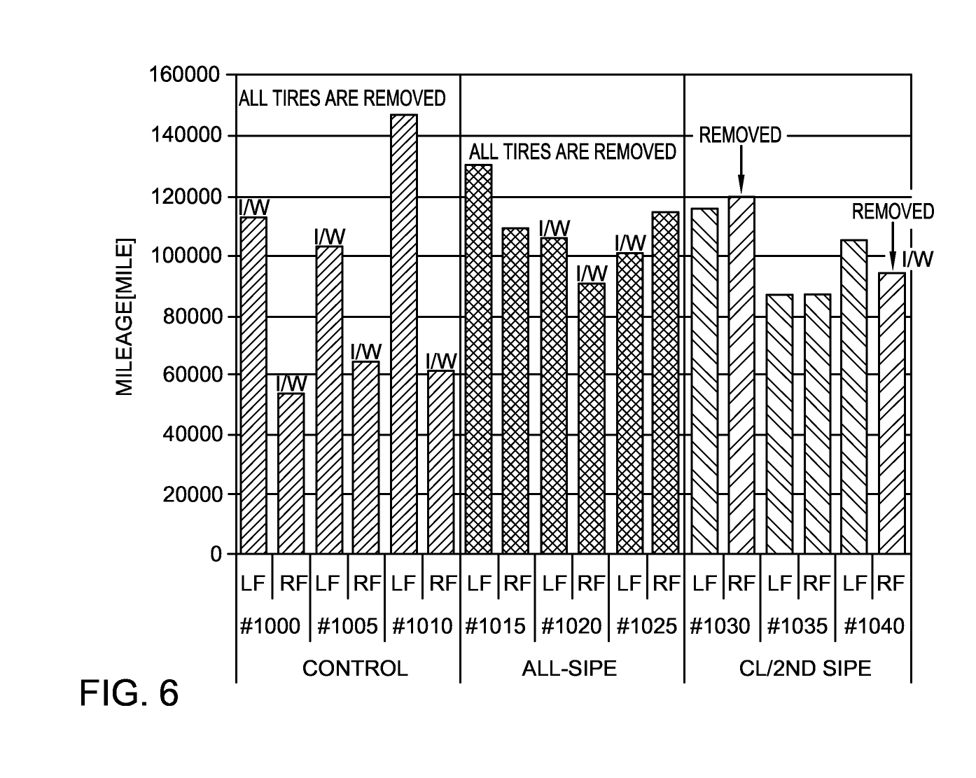

FIG. 5 is a graph showing some of the results from the first set of tests, the second set of tests, and the third set of tests. FIG. 5 is a graph of miles of travel per millimeter of tread wear, MPM, measured in miles/mm, versus remaining tread depth, RTD, measured in mm. Each of the tires 300, 400, 500, in each of the sets of tests had an original tread depth, OTD, of 13.0 mm. The average MPM for each of the first set of tests, the second set of tests, and the third set of tests is shown as a large circle in FIG. 5. The data in FIG. 5 shows that the average MPM for the first set of tests was 15321 miles/mm. The data in FIG. 5 shows that the average MPM for the second set of tests was 20821 miles/mm, a 36% improvement over the average MPM for the first set of tests. The data in FIG. 5 shows that the average MPM for the third set of tests was 19291 miles/mm, a 25% improvement over the average MPM for the first set of tests. These results are summarized in TABLE 1 below. In brief, the results from the first set of tests, the second set of tests, and the third set of tests provide evidence that the tires 300, 400 with tire treads comprising sipes 350, 450 undergo substantially less tread wear per mile than do tires 200 with tire tread 210 which comprises rib edge cavities 240, but lacks sipes 350, 450.

FIG. 6 is a graph showing test mileage at termination from testing for various test tires from the first set of tests, the second set of tests, and the third set of tests. Testing for all of the tires 200 in the first set of tests was terminated for irregular wear. The average removal mileage for the tires 200 in the first set of tests was 90500 miles. Testing for all of the tires 300 in the second set of tests was terminated for irregular wear. The average removal mileage for the tires 300 in the second set of tests was 109072 miles, a 21% improvement over the average removal mileage for the first set of tests. Testing for two of the tires 400 in the third set of tests was terminated for irregular wear. The average removal mileage for the tires 400 in the third set of tests was 107304 miles, a 19% improvement over the average removal mileage for the first set of tests. These results are summarized in TABLE 1 below. In brief, the results from the first set of tests, the second set of tests, and the third set of tests provide evidence that the tires 300, 400 with tire treads comprising sipes 350, 450 have a longer usable life as measured in miles than do tires 200 with tire tread 210 which comprises rib edge cavities 240, but lacks sipes 350, 450.

TABLE 1 summarizes the results from testing.

TABLE 1

| | | | Average | |
|---|---|---|---|---|
| | | Normal- | Removal | Normalized |
| | Average MPM | ized | Mileage | Removal |
| | [Miles/mm] | MPM | [miles] | Mileage |
| First Test Set | 15321 | 100 | 90500 | 100 |
| Second Test Set | 20821 | 136 | 109072 | 121 |
| Third Test Set | 19291 | 125 | 107304 | 119 |

It is believed that a tire with tire tread comprising sipes of the nature disclosed herein provide improved tread wear and traction performance.

Without limitation, it is believed that a tire with tire tread comprising sipes of the nature disclosed herein may be suitable for use as a heavy duty tire, such as a truck or bus tire.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A tire tread for a tire, said tire tread comprising,
a plurality of ribs or blocks, each of said ribs or blocks having
a length extending in a circumferential direction,
a width extending in an axial direction, and
a depth extending in a radial direction;
a plurality of grooves defined by adjacent ribs or blocks;
a plurality of sipes formed in at least one of said ribs or blocks,
each of said sipes extending at an angle to the axial direction, where the angle of each sipe is
within a first range of angles, where all angles are
equal to or greater than 0 degrees, and
equal to or less than 70 degrees, or
within a second range of angles, where all angles are
equal to or greater than −70 degrees, and
equal to or less than 0 degrees,
each sipe having a thickness
greater than nano thickness, and
less than or equal to 2.00 mm,
each sipe being spaced along the circumferential direction from an adjacent sipe by some interval having a length, where the length of the interval does not exceed 20 mm; and
wherein there is a ratio of the length of the interval to length of a contact patch which would be created by subjecting the tire to its standard load at its standard inflation pressure, said ratio being less than 0.062.

2. The tire tread of claim 1, wherein each sipe has a thickness
greater than 0.10 mm, and
less than or equal to 0.45 mm.

3. The tire tread of claim 2, wherein the interval does not exceed 17 mm.

4. The tire tread of claim 3, wherein a sipe has a length that is at least 70% of the width of the rib or block in which the sipe is formed.

5. The tire tread of claim 1, wherein each sipe has a thickness
greater than 0.15 mm, and
less than or equal to 0.40 mm.

6. The tire tread of claim 5, wherein the interval does not exceed 15 mm.

7. The tire tread of claim 6, wherein a sipe has a length that is at least 80% of the width of the rib or block in which the sipe is formed.

8. The tire tread of claim 1, wherein each sipe has a thickness
greater than 0.25 mm, and
less than or equal to 0.35 mm.

9. The tire tread of claim 8, wherein the interval does not exceed 13 mm.

10. The tire tread of claim 9, wherein a sipe has a length that is at least 90% of the width of the rib or block in which the sipe is formed.

11. A method of forming a tire tread, said method comprising,
forming a plurality of ribs or blocks, each of said ribs or blocks having
a length extending in a circumferential direction,
a width extending in an axial direction, and
a depth extending in a radial direction;
forming a plurality of grooves defined by adjacent ribs or blocks; and
forming a plurality of sipes formed in at least one of said ribs or blocks,
each of said sipes extending at an angle to the axial direction, where the angle of each sipe is
within a first range of angles, where all angles are
equal to or greater than 0 degrees, and
equal to or less than 70 degrees, or
within a second range of angles, where all angles are
equal to or greater than −70 degrees, and
equal to or less than 0 degrees,
each sipe having a thickness
greater than nano thickness, and
less than or equal to 2.00 mm,
each sipe being spaced along the circumferential direction from an adjacent sipe by some interval having a length, where the length of the interval does not exceed 20 mm,
wherein there is a ratio of the length of the interval to length of a contact patch which would be created by subjecting the tire to its standard load at its standard inflation pressure, said ratio being less than 0.062.

12. The method of forming a tire tread of claim 11, wherein each sipe has a thickness
greater than 0.10 mm, and
less than or equal to 0.45 mm.

13. The method of forming a tire tread of claim 12, wherein the interval does not exceed 17 mm.

14. The method of forming a tire tread of claim 13, wherein a sipe has a length that is at least 70% of the width of the rib or block in which the sipe is formed.

15. The method of forming a tire tread of claim 11, wherein each sipe has a thickness
greater than 0.15 mm, and
less than or equal to 0.40 mm.

16. The method of forming a tire tread of claim 15, wherein the interval does not exceed 15 mm.

17. The method of forming a tire tread of claim 16, wherein a sipe has a length that is at least 80% of the width of the rib or block in which the sipe is formed.

18. The method of forming a tire tread of claim 11, wherein each sipe has a thickness
greater than 0.25 mm, and
less than or equal to 0.35 mm.

19. The method of forming a tire tread of claim 18, wherein the interval does not exceed 13 mm.

20. A tire tread for a tire, said tire tread comprising,
a plurality of ribs or blocks, each of said ribs or blocks having
a length extending in a circumferential direction,
a width extending in an axial direction, and
a depth extending in a radial direction;
a reference direction extending at some reference angle to the axial direction, wherein said reference angle is between −60 and 60 degrees, inclusive;
a plurality of sipes formed in at least one of said ribs or blocks,
each of said sipes extending at a deviation angle with respect to the reference direction, where the deviation angle is between −10 and 10 degrees, inclusive,
each sipe having a thickness
greater than nano thickness, and
less than or equal to 2.00 mm,
each sipe being spaced along the circumferential direction from an adjacent sipe by some interval having a length, where the length of the interval does not exceed 20 mm; and
wherein there is a ratio of the length of the interval to length of a contact patch which would be created by subjecting the tire to its standard load at its standard inflation pressure, said ratio being less than 0.062.
